(19) United States
(12) Patent Application Publication
(10) Pub. No.: US 2014/0003322 A1
(43) Pub. Date: Jan. 2, 2014

(54) SEAMLESS MAKE-BEFORE-BREAK TRANSFER OF MULTICAST/BROADCAST SESSIONS

(71) Applicants: Edward Grinshpun, Freehold, NJ (US); Zulfiquar Sayeed, Hightstown, NJ (US)

(72) Inventors: Edward Grinshpun, Freehold, NJ (US); Zulfiquar Sayeed, Hightstown, NJ (US)

(73) Assignee: ALCATEL-LUCENT USA INC., Murray Hill, NJ (US)

(21) Appl. No.: 13/924,378

(22) Filed: Jun. 21, 2013

Related U.S. Application Data
(60) Provisional application No. 61/666,038, filed on Jun. 29, 2012.

(51) Int. Cl. H04W 36/30

(52) U.S. Cl. CPC H04W 36/30
USPC 370/312

(57) ABSTRACT

Multicast/broadcast offload session (MBOS) anchor logic is provided to establish an offload session to an MBOS gateway to provide a multicast/broadcast stream to user equipment in response to the user equipment handing off from a first access point to a second access point. The MBOS anchor logic is to establish the offload session concurrently with providing the multicast/broadcast stream to the user equipment via the first access point. MBOS gateway logic is provided to terminate the offload session and forward content to the user equipment. User equipment including MBOS management logic is provided to trigger establishment of the offload session terminated by the MBOS gateway for providing a multicast/broadcast stream to the user equipment in response to the user equipment handing off from a first access point to a second access point. The trigger is provided concurrently with the user equipment receiving the multicast/broadcast stream via the first access point.

### CROSS REFERENCE TO RELATED APPLICATIONS

This application claims priority to U.S. Provisional Patent Application No. 61/666,038, filed on Jun. 29, 2012. This application is also related to U.S. patent application Ser. No. 13/772,076, filed Dec. 20, 2012, which is incorporated herein by reference in its entirety and which claims priority to U.S. Provisional Patent Application 61/666,122 filed on Jun. 29, 2012.

### BACKGROUND

1. Field of the Disclosure

The present disclosure relates generally to communication systems, and, more particularly, to wireless communication systems.

2. Description of the Related Art

Wireless communication systems use a network of access points such as base stations to provide wireless connectivity to access terminals, such as mobile units, smart phones, or other devices that are enabled for wireless communication. The coverage area of a wireless communication system is typically divided into a number of geographic areas that are conventionally referred to as cells or sectors. The coverage area of each cell in the wireless network is limited by the propagation loss of radio signals transmitted by access points that provide coverage to the cell. Thus, the coverage area of each cell is determined by the location and the transmit power of the access point, as well as other factors including the geography of the cell and the location of any interfering objects. For example, the coverage area of a cell may be reduced if a building or a mountain is present near the access point. The boundaries of the cells are not rigidly defined and may vary with time due to long-term or short-term radiofrequency variations. Thus, coverage areas may overlap such that multiple access points may provide coverage to the overlapping regions, although the strength of the signal provided within the overlapping regions may be different for the different access points. For example, the boundaries of cells in some wireless communication systems may be designed to overlap to produce gains in diversity reception from multiple base stations. These wireless communication systems may be referred to as single frequency networks (SFNs).

Wireless communication standards such as Long Term Evolution (LTE, LTE-Advanced) support broadcasting or multicasting services such as the multimedia broadcast multicast service (MBMS) or the enhanced multimedia broadcast multicast service (eMBMS). The MBMS services broadcast or multicast data from base stations over the air interface on channels that can be received by one or more users. The eMBMS is an enhanced version of MBMS that provides additional features such as an architecture and physical layer enhancements that allow the eMBMS service to carry multimedia information to user equipment. The term “MBMS” may be used to refer to either MBMS or eMBMS depending on the context. Typically, users subscribe to particular programs that they may then receive using the MBMS service. Once a user has subscribed to a program and begun to receive the program, the user expects to receive the program without interruption even though the user may move into or out of buildings, cars, buses and the like. However, any obstruction between the user and a base station can cause channel losses that reduce the signal strength of the MBMS signal. For example, building penetration losses are typically on the order of 11-20 dB and car penetration losses are typically on the order of 7 dB. These channel losses may be referred to as indoor penetration losses.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system in accordance with some embodiments.

FIG. 2 is a block diagram of a wireless communication system that supports seamless make-before-break session transfers in accordance with some embodiments.

FIG. 3 is a block diagram that shows concurrent multicast/broadcast and offload sessions for conveying packets from a multicast/broadcast stream provided by a content provider during a make-before-break transition in accordance with some embodiments.

FIG. 4 is a block diagram of a wireless communication system that supports seamless make-before-break session transfers in accordance with some embodiments.

FIG. 5 is a block diagram of a wireless communication system that supports seamless make-before-break session transfers in accordance with some embodiments.

FIG. 6 is a flow diagram of a method for seamless make-before-break transfer of a multicast/broadcast session to an offload session in accordance with some embodiments.

FIG. 7 is a flow diagram of a method for ending communication between MBOS management logic in a user equipment and MBOS anchor logic in a wireless communication system in accordance with some embodiments.

### DETAILED DESCRIPTION

As discussed herein, any obstruction between user equipment and an access point such as a base station can cause channel losses that reduce the signal strength of the MBMS signal. Channel losses reduce the coverage area of base stations in the wireless communication system. For a given transmission power, the approximate radius (R) of the coverage area may be related to the loss ratio (in dB) by the equation:

R=const×10^{-loss in dB}

The constant in this equation may be determined empirically, theoretically, experimentally, or using other techniques. The area (A_{BS}) covered by an individual base station that provides uniform coverage is approximately proportional to R² and so the number of base stations required to provide coverage to an area (A_{cov}) is approximately given by:

$$N \text{\textasciitilde} \frac{{A}_{cov}}{{A}_{BS}} \text{\textasciitilde} \frac{{A}_{cov}}{{R}^{2}} \text{\textasciitilde} {10}^{2 \times loss in dB}$$

The number of base stations needed to cover the area (A_{cov}) thus increases exponentially as the expected channel losses (in dB) increase. The large channel losses created by building penetration or car penetration therefore significantly increase the link budget (e.g., the number of base stations or the transmission power of individual base stations) needed to provide ubiquitous coverage for MBMS services. Consequently, simply increasing the transmit powers of the base stations or increasing the number of base stations to compensate for the indoor penetration loss would lead to an impractical cost increase for service providers.

One approach to addressing indoor penetration toss is to provide an indoor gateway that can establish a broadcast or multicast service with user equipment within a building, car, bus, train, or other obstruction. User equipment within existing broadcast or multicast session can then be offloaded to the indoor gateway, e.g., the existing multicast/broadcast session can be transferred from a base station to the indoor gateway. Some embodiments of techniques for establishing multicast/broadcast sessions within indoor gateway are described in application Ser. No. 13/772,076, which is incorporated herein by reference in its entirety.

However, conventional network-side equipment is not well-suited for offloading multicast traffic from base stations to other wireless access points such as indoor gateways. For example, the Third Generation Partnership Project (3GPP) has standardized methods of offloading traffic to Wi-Fi access points, femtocells, or home eNodeBs such as selected Internet Protocol (IP) traffic offload (SIPTO), local IP access (LIPA), IP flow mobility (IFOM), and multi-access packet data node (PDN) connectivity (MAPCON). These methods are designed to support unicast traffic and do not provide for seamless multicast/broadcast offloading. In particular, conventional systems do not account for the presence of other users receiving the multicast stream and do not provide for multicast flow duplication or replication that is needed for seamless offloading. For another example, conventional IP television (IPTV) is designed to provide IP multicast over wired broadband connections and is not suited for seamless session transitions between an outdoor multicast/broadcast session and an indoor session with wired backhaul access. In particular, gateways can dynamically join an IPTV multicast session but do not support seamless mobility of attached end-user devices like smartphones or tablets across different wireless media especially when transitioning between indoor and outdoor environment with different wireless penetration levels.

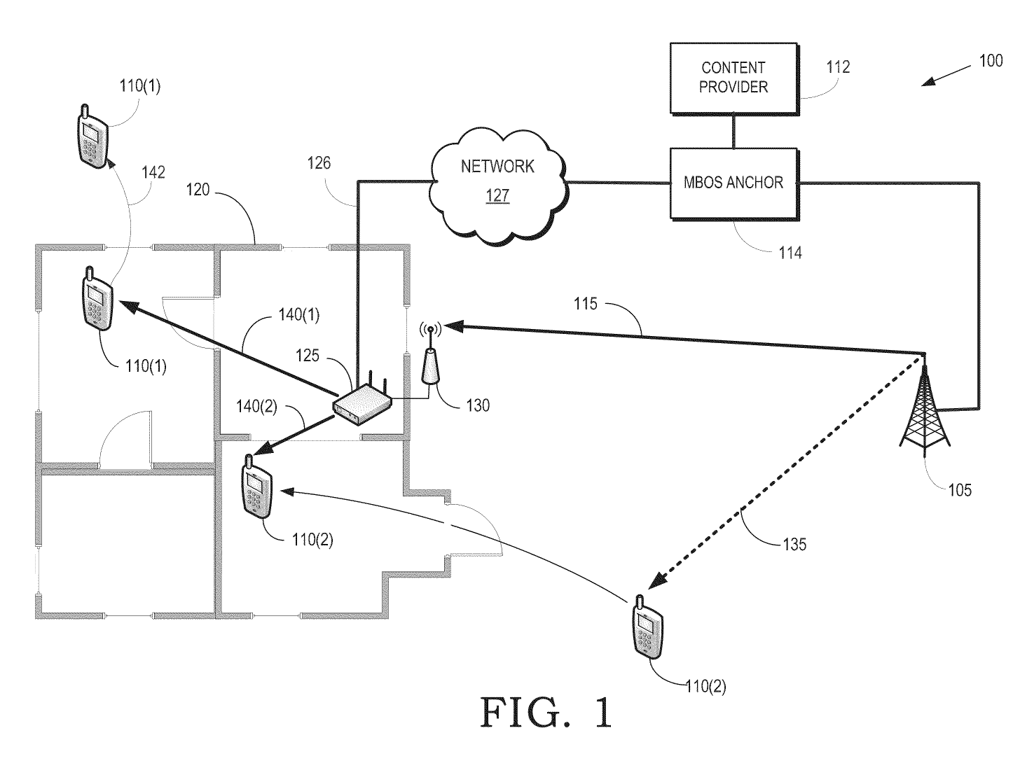

At least in part to address these drawbacks in conventional wireless communication systems, FIGS. 1-7 describe embodiments of a wireless communication system that includes a multicast/broadcast offload session (MBOS) manager function, an MBOS anchor function, and a MBOS gateway function. The MBOS anchor may be implemented within or outside of a wireless service provider's network and is used to control a make-before-break session transfer between an access point within an obstructed area and an access point outside the obstructed area. During a make-before-break session transfer, the user equipment concurrently maintains an offload session with the access point in the obstructed area and a multicast/broadcast session with the access point outside the obstructed area. The offload session is used to convey copies of the multicast/broadcast packets to the access point in the obstructed area over a broadband connection, e.g., by unicasting or tunneling the packets.

The MBOS anchor may replicate content in the multicast/broadcast flow during the make-before-break session transfer and time synchronize duplicate flows transmitted towards the different access points for eventual transmission to the user equipment. For example, one copy of the packets from the multicast/broadcast flow can be transmitted using the multicast/broadcast session and another copy of the packets can be transmitted using the offload session. The MBOS gateway is used to terminate the offload session that conveys the packets that are destined for user equipment associated with the access point in the obstructed area. The MBOS manager is implemented in user equipment to receive the replicated, time-synchronized copies of the packets in the multicast/broadcast stream and packets in the offload session and manage transitions between the multicast/broadcast stream and the offload session. For example, the MBOS manager may perform uniform “reverse repackaging” of received packets so that the application layer does not see a difference between received packet headers for packets selected from MBMS stream that is IP multicast and packets selected from the offload session because the packets selected from the offload session may be “repackaged” as IP unicast for delivery to the application layer. Since the MBOS manager can choose between the replicated, time-synchronized packets, embodiments of the wireless communication system described herein support seamless transition of a multicast/broadcast session into and out of an obstructed area without impacting other user equipment that may be subscribed to the same multicast/broadcast session.

FIG. 1 is a block diagram of a wireless communication system 100 in accordance with some embodiments. In the illustrated embodiment, an access point 105 is used to provide broadcast or multicast services to a corresponding geographic area or cell, which may include one or more user equipment 110. As used herein, the term “access point” will be understood to refer to a device that provides wireless connectivity to user equipment 110 within a corresponding geographic area. The term “access point” may therefore encompass base stations, base station routers, eNodeBs, macrocells, microcells, femtocells, picocells, and other types of devices. For example, the access point 105 may be an eNodeB that provides wireless connectivity according to 3GPP standards or other cellular communication standards. A content provider 112 may provide content to the access point 105 for eventual transmission. For example, the content provider 112 may provide packets to the access point 105 as part of a multicast/broadcast session to user equipment 110 that have subscribed to the multicast/broadcast session.

A building 120 may be located within the geographic area served by the access point 105. As discussed herein, obstructions such as the doors, windows, or wails of the building 120 may significantly increase channel loss between the user equipment 110 and the access point 105. Exemplary building penetration losses are typically on the order of 11-20 dB and car penetration losses are typically on the order of 7 dB. For a given transmission power, the penetration losses may degrade the quality of the broadcast or multicast service or cause the service to be lost. Larger system link budgets may therefore be necessary to overcome the penetration losses while providing a particular quality of service within the building 120.

An interior access point 125 may be deployed within the building 120. Some embodiments of the access point may provide wireless connectivity according to Wi-Fi standards or other wireless communication standards. The access point 125 may then be physically, electromagnetically, or communicatively coupled to the content provider via a broadband connection or backhaul link. Some embodiments of the broadband connection are implemented as a wired broadband connection 126 that connects the access point 125 to the content provider 112 via a network 127. Other embodiments of the broadband connection, which may be implemented in addition to or instead of the wired broadband connection 126, may be a wireless broadband connection that includes an antenna 130 that is deployed outside of the building 120, e.g., by mounting the antenna 130 on an exterior surface of the building 120. For example, the access point 125 may be coupled to the antenna 130 using a cable that passes from the exterior to the interior of the building 120. For another example, a wireless link may be established between the interior access point 125 and the exterior antenna 130. Some embodiments of the access point 125 may alternatively be deployed exterior to the building 120 so that the wireless broadband connection can be formed directly to the access point 125. For example, the access point 125 and the antenna 130 may be implemented in a single box, which may be hardened to withstand environmental conditions expected exterior to the building 120. Some embodiments of the wireless communication system may include other obstructions such as vehicles and the access point 125 and wired or wireless broadband connection may be deployed in, on, or proximate these obstructions, as discussed herein.

User equipment 110(1) is located interior to the building 120 and the signal path from the base station 105 to the user equipment 110(1) may therefore be obscured by walls, doors, or windows in the building 120. Instead of receiving multicast/broadcast services from the content provider 112 via the obscured base station 105, user equipment 110(1) may transmit a request to the access point 125 to receive the multicast/broadcast services via the access point 125 using a wired or wireless broadband connection to a multicast/broadcast offload session (MBOS) anchor 114 that receives packets from the content provider 112 as part of a multicast/broadcast session. As used herein, the term “multicast/broadcast session” should be understood to refer to a session that can be used to carry transmissions of broadcast or multicast services. Examples of multicast/broadcast sessions include, but are not limited to, MBMS sessions or eMBMS sessions. Furthermore, the broadcast/multicast session does not necessarily carry either broadcast or multicast services at any particular time because the transmissions may depend on the available programming and the choices made by individual users. A multicast/broadcast session may implement IP headers that may include broadcast or multicast IP addresses. The IP headers may be read by multicast supporting routers and used to direct multicast packets in accordance with IP multicast protocols such as the Internet Group Management Protocol (IGMP). Some embodiments of multicast/broadcast sessions may also use broadcast/multicast MAC layer media (cg, LTE eMBMS equipment), single frequency networks (SFNs), allocation of multicast channels, or Wi-Fi/Ethernet using broadcast/multicast MAC addresses.

The access point 125 may establish an offload session to receive packets associated with the requested broadcast/multicast session from the content provider 112 in response to the request from the user equipment 110(1). As used herein, the term “offload session” is used to indicate a session that conveys content from the multicast/broadcast session over a broadband connection to the access point 125, e.g., using the wired broadband connection 126, 127 or the wireless broadband connection 115. For example, copies of the broadcast/multicast packets may be unicast, multicast, or tunneled over the broadband connection to the access point 125. When using the wireless broadband connection 115, the offload session may be referred to as an exterior session to indicate that the signal path or paths between the antenna 130 and the access point 105 is substantially outside of the building 120. Persons of ordinary skill in the art having benefit of the present disclosure should appreciate that the phrase “substantially outside” is intended to mean that the signal path or paths of the session remains predominantly outside of the building 120 or other structures. However, portions of one or more of the path(s) of the session may pass through other structures or environmental obstacles even though the path is “substantially outside” of the building 120. These portions are expected to be small relative to the overall length of the path(s).

The access point 125 may also establish a distribution session 140(1) with the user equipment 110(1). The distribution session 140(1) may be referred to as an interior session to indicate that the signal path between the access point 125 and the user equipment 110(1) is substantially within the building 120. Some embodiments of the distribution session 140(1) may be configured to unicast packets from the content stream to user equipment 110(1) using IP unicast with transmission control protocol (TCP) over Wi-Fi or user datagram protocol (UDP). Some embodiments of the distribution session 140(1) may be configured to multicast packets from the content stream to user equipment 110(1), as well as other user equipment. Other embodiments of the distribution session 140(1) may be carried over other access media including, but not limited to, wired Ethernet access, femtocells, picocells, base station routers, or other types of wired or wireless access. In some embodiments, the distribution session 140(1) may be established with multiple user equipment 110 and content may therefore be multicast from the access point 125 to user equipment 110. As discussed herein, session managers (not shown in FIG. 1) in the user equipment 110(1) and the access point 125 may be used to negotiate, authenticate, time synchronize, or “tie together” the interior distribution session 140(1) and the exterior offload session into a single multimedia application session.

If the user equipment 110(1) moves outside of the building 120, as indicated by the arrow 142, an MBOS manager (not shown) implemented in the user equipment 110(1) may join or tune to a multicast/broadcast channel that is transmitted over an air interface to the access point 105 and begin concurrently receiving the multicast/broadcast packets using the distribution session 140(1) and the multicast/broadcast channel. Logic in the user equipment 110(1) may perform packet selection to support a seamless make-before-break between the distribution session 140(1) and the multicast/broadcast session carried by the multicast/broadcast channel. Once the outdoor route is established, the distribution session 140(1) may be torn down. If the user equipment 110(1) was the only device receiving the multicast/broadcast session within the building 110, the offload session may also be torn down.

In some embodiments, user equipment 110(2) may transition existing broadcast or multicast services from an exterior location to an interior location. In the illustrated embodiment, user equipment 110(2) is located in the cell and has subscribed to the broadcast/multicast service provided by the access point 105. User equipment 110(2) has therefore joined or tuned to a broadcast/multicast session, as indicated by the dashed line 135. User equipment 110(2) may be actively receiving broadcast or multicast transmissions using the multicast/broadcast session or, alternatively, user equipment 110(2) may have subscribed to a future broadcast or multicast transmission and established the broadcast/multicast session for receiving the broadcast or multicast transmission at a subsequent scheduled time. The user equipment 110(2) may be mobile while receiving the broadcast or multicast transmissions over the air interface 135 or prior to receiving a scheduled broadcast or multicast transmission. The user may carry the user equipment 110(2) into a building, a vehicle, or other structure that obstructs or intervenes along the signal path from the access point 105 to user equipment 110(2). The user equipment 110(2) depicted in FIG. 1 moves from a location that is exterior to a building 120 to a location that is interior to the building 120. However, some embodiments of the techniques described herein apply equally to user equipment 110 that move into a vehicle or other structure that may obscure signals transmitted by the base station 105.

The access point 125 may establish an offload session with the MBOS anchor 114 in response to the user equipment 110(2) moving proximate to the access point 125 or entering the building 120. Some embodiments of the user equipment 110(2) can monitor the signal strength associated with a signal such as a pilot signal transmitted by the access point 125 or other parameters such as a received signal strength indicator (RSSI) associated with a broadcast channel, packet loss, delay, video session specific analytics, location of the user equipment 110(2), or distance between the user equipment 110(2) and the access point 125 to determine whether to trigger a hand off to the access point 125. When the user equipment 110(2) determines that a handoff condition has been satisfied, such as the signal strength exceeding a threshold, the user equipment 110(2) may trigger handoff and attach to the access point 125. In some embodiments, other entities in the network may determine whether to trigger hand off the user equipment 110(2). For example, the 3GPP Access Network Discovery and Selection function in the network may be used to trigger hand off. The user equipment 110(2) may then signal to the access point 125 that it has an ongoing multicast service or a scheduled multicast service associated with the multicast/broadcast session conveyed over the air interface 135 and trigger establishment of the offload session between the access point 125 and the MBOS anchor 114. The access point 125 may also establish a distribution session 140(2) with the user equipment 110(2) in response to triggering establishment of the offload session.

As discussed herein, session managers (not shown in FIG. 1) in the user equipment 110(2) and the access point 125 may be used to negotiate, authenticate, time synchronize, or “tie together” the distribution session 140(2) and the offload session into a single multimedia application session. In some embodiments, the session managers may include a multicast/broadcast offload session (MBOS) anchor logic, MBOS gateway, and MBOS management logic.

MBOS anchor logic implemented on the network side may establish the offload session to an MBOS gateway that may be implemented in the access point 125 or user equipment 110. For example, the offload session may include a tunnel established between the MBOS anchor logic and the MBOS gateway. For example, the tunnel may be established using a unicast outer IP header. For another example, “multicast tunnels” may be used to allow concurrent offload to multiple homes or offices. A multicast tunnel may be established when an MBOS anchor initiates a multicast tunnel session over wired broadband, e.g., by enveloping original packets into multicast headers. The MBOS gateways can then join the multicast tunnel session, e.g. using IGMP or IPv6 Multicast Listener Discovery (MLD)).

The endpoints of the tunnel may be defined by addresses (such as IP addresses) of the MBOS anchor logic and the MBOS gateway. Packets transmitted along the tunnel may be encapsulated in a header that includes the addresses of the endpoints. The encapsulated packets may also be encrypted so that only the authenticated endpoints of the tunnel can decrypt information in the encapsulated packets. The MBOS gateway may then receive a multicast/broadcast stream associated with the multicast/broadcast session via, the tunnel and provide the multicast/broadcast stream to MBOS management logic implemented in user equipment 110. The MBOS anchor logic may establish the tunnel concurrently with providing the multicast/broadcast stream to the user equipment 110 via the access point 105. Thus, the MBOS anchor logic, MBOS gateway, and MBOS management logic may be used to coordinate a seamless make-before-break transition of the multicast/broadcast session from the access point 105 to the access point 125, as explained further herein.

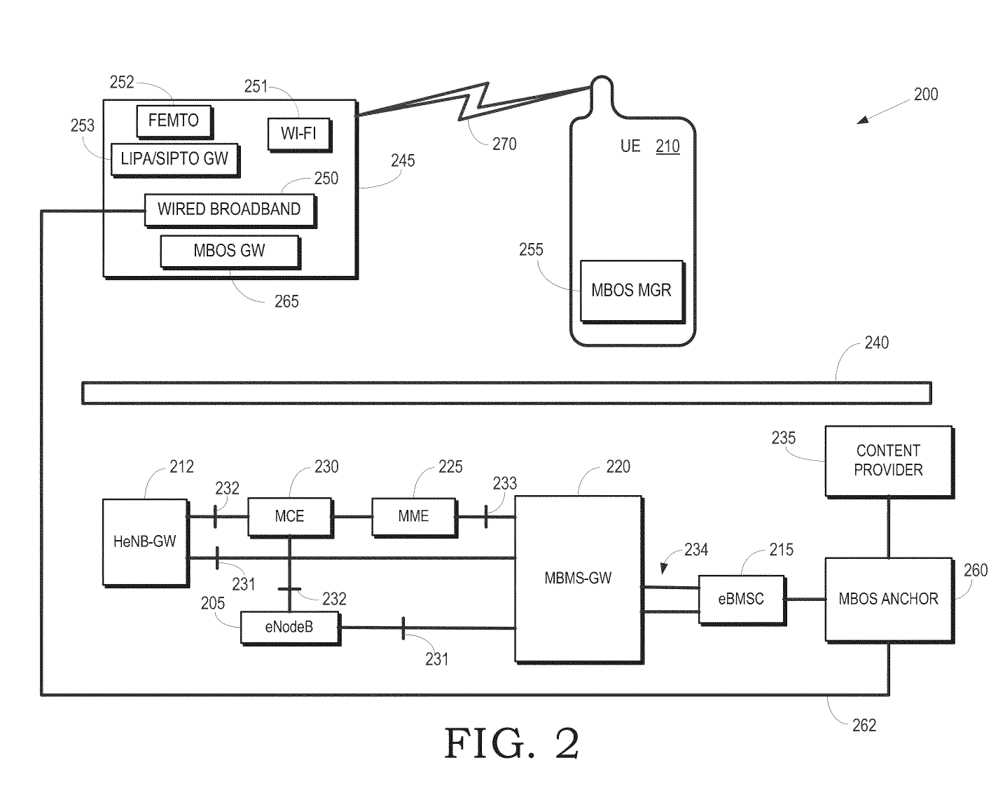

FIG. 2 is a block diagram of a wireless communication system 200 that supports seamless make-before-break session transfers in accordance with some embodiments. Some embodiments of the wireless communication system 200 include an access point such as an eNodeB (eNB) 205 that can be configured to provide wireless connectivity to one or more user equipment 210. Some embodiments of the eNB 205 may transmit enhanced MBMS (eMBMS) bearers for one or more eMBMS user services. The wireless communication system 200 may also include a home eNodeB gateway 212 that can aggregate traffic from a large number of home (indoors) located eNBs back to the core network. For example, the eNodeB gateway 212 may be used as a concentrator for the control plane (e.g., an S1-MME connection between the MME 225 and an heNB) and may optionally carry the user plane S1-U or S1-U may be carried over another logical channel such as a wired secondary channel between a serving gateway (S-GW) and one or more HeNBs.

The wireless communication system 200 shown in FIG. 2 includes a broadcast multicast service center (BMSC) 215 that provides functions for initiating broadcast or multicast user service and delivery. Some embodiments of the BMSC 215 provide functions for eMBMS user service provisioning and delivery and the BMSC 215 may be the entry point for content provider eMBMS transmissions. Some embodiments of the BMSC 215 may be used to authorize and initiate eMBMS Bearer Services within the public land mobile network (PLAN) and to schedule and deliver eMBMS transmissions.

The wireless communication system 200 also includes an MBMS gateway 220 that can broadcast or multicast packets to each base station or eNB 205 that may be transmitting a broadcast or multicast service to user equipment 210. Some embodiments of the gateway 220 may be responsible for sending or broadcasting of MBMS bearer data to each eNB 205 that may be transmitting the service. The MBMS GW 220 may use IP Multicast as the means of forwarding MBMS user data to the eNB 205. For example, the MBMS Gateway 220 can transmit multicast packets to each eNB in a multicast-broadcast single frequency network (MB-SFN) area (including the eNB 210) using Internet Protocol (IP) multicasting. The MBMS Gateway 220 may also perform header compression or other operations for the multicast services. The MBMS GW 220 also performs MBMS Session Control towards the E-UTRAN via one or more mobility management entities.

The wireless communication system 200 depicted in FIG. 2 includes a mobility management entity (MME) 225 that provides MBMS session control functions and connects the broadcast-only functions (BMSC and MBMS-GW) with the E-UTRAN. Some embodiments of the MME 225 may be a control-node for the LYE access network and may be responsible for idle mode tracking and paging of the user equipment 210. The MME 225 may also be involved in the bearer activation/deactivation process and may be responsible for choosing a serving gateway (not shown in FIG. 2) for user equipment 210 at the initial attach and at time of intra-LTE handover involving Core Network (CN) node relocation. The MME 225 may also be responsible for authenticating user equipment 210.

A multi-cell (or multicast) coordination entity (MCE) 230 may be connected to all the cells in an MB-SEN area. Some embodiments of the MCE 230 provide admission control functions and may coordinate radio resource allocations for eNBs in an MB-SEN area. The MCE 230 may be involved in MBMS Session Control and may allocate radio resources used by the eNBs within an MB-SEN area including the eNB 205. The MCE 230 may therefore ensure that the same resource blocks are allocated for a given service across all the eNBs of a given MB-SEN area. The MCE 230 may also configure MB-SEN subframes for multicast control or data broadcasts as well as providing information to configure the L2/L3 layers in the eNBs including the eNB 205. Some embodiments of the MCE 230 may also coordinate operation of the eNBs so that all eNBs transmit the same MBMS data in a time synchronous manner.

In some embodiments, the eNB 205 and the home eNB gateway 212 are connected to the MBMS gateway 220 by interfaces 231 such as the M1 interface defined by 3GPP standards. The eNB 205 and the home eNB gateway 212 may also be connected to the MCE 230 by interfaces 232 such as the M2 interface defined by 3GPP standards. The MME 225 may be connected to the MBMS gateway 220 by an interface 233 such as the Sm interface defined by the 3GPP standards. The MBMS gateway 220 may be connected to the BMSC 215 by interfaces 234 such as the SG-mb and SG-imb interfaces defined by the 3GPP standards.

A content provider 235 may be used to provide content that is to be transmitted to user equipment 210, e.g., by being broadcast, multicast, or unicast to the user equipment 210. For example, the content provider 235 may provide a multicast/broadcast stream using a corresponding multicast/broadcast session established with one or more user equipment 210. Some embodiments of the wireless communication system 200 implement the content provider 235 within the system 200 and other embodiments of the wireless communication system 200 may receive content from a third party content provider 235 that is implemented outside of the wireless communication system 200.

An obstruction 240 intervenes between the base station 205 and user equipment 210 shown in FIG. 2. Consequently, as discussed herein, the signal strength of signals transmitted over an air interface with the eNB 205 may be reduced or degraded. For example, as discussed herein, penetration losses due to propagation through the obstruction 240 may be on the order of 11-20 dB if the obstruction 240 is a portion of a building or on the order of 7 dB if the obstruction 240 is a portion of a car or other vehicle. User equipment 210 may therefore opt to receive packets from the multicast/broadcast session via an access point 245. Some embodiments of the access point 245 have a wired broadband backhaul connection 250 to connect the access point 245 to the MBOS anchor 260 over the wired broadband connection 262. Alternatively, a wireless backhaul (not shown) may be implemented. The access point 245 can provide wireless connectivity to user equipment 210 via one or more access technologies that include Wi-Fi 251, wired ethernet, LTE using femtocell or Home enodeB 252, or other wired or wireless technologies. Some embodiments of the access point 245 may also include logic for implementing a LIPA/SIPTO gateway 253. Techniques for implementing the LIPA/SIPTO gateway 253 are known and in the interest of clarity are not discussed in detail herein.

Some embodiments of the user equipment 210 may trigger a make-before-break session transfer from the multicast/broadcast session received over the air interface from the eNB 205 to an offload session established over the broadband connection 262 between an MBOS anchor 260 and an MBOS gateway 265. Some embodiments of the offload session made use either unicasting or multicasting to convey copies of the multicast/broadcast packets. The offload session may be implemented as a dedicated IP tunnel, in which case a tunnel IP header may be added to the original IP packets from the multicast/broadcast session. Other types of tunnels may also be used in some embodiments. The multicast/broadcast content may also be repackaged by replacing the original IP header with a different header to ensure delivery to the endpoint of the offload session. Some embodiments of the offload session may use transfer control protocol (TCP), user datagram protocol (UDP), or other IP delivery methods for tunneling or repackaging of the multicast/broadcast content.

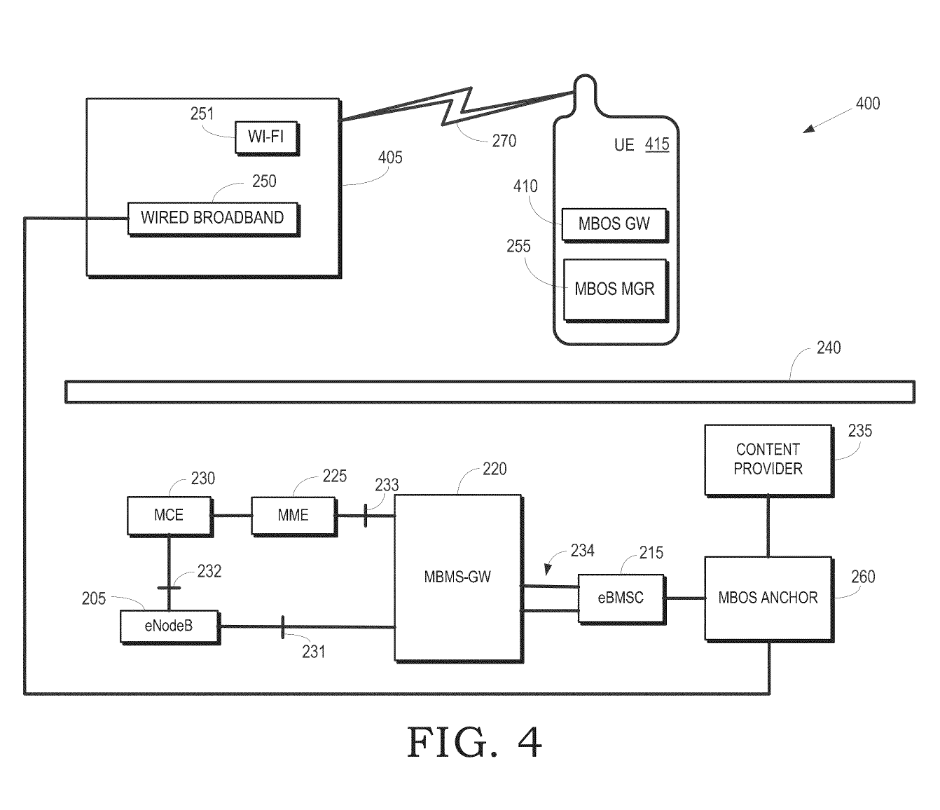

The seamless make-before-break transfer of the multicast/broadcast session to the offload session between the access point 245 and the eNB 205 is coordinated by MBOS management logic 255 implemented in user equipment 210, the MBOS anchor logic 260 implemented on the network side, and the MBOS gateway logic 265, which may be implemented in the access point 245 (as shown in FIG. 2) or in user equipment 210 (as shown in FIG. 4).

Some embodiments of the MBOS management logic 255 perform the seamless session transfer subject to constraints imposed by the end-user quality-of-experience metrics. For example, the MBOS management logic 255 may perform the session transition from the multicast/broadcast session to the offload session so that interruptions in the transmission are less than a value in a range from 10 milliseconds to 300 milliseconds, depending on the application. The MBOS management logic 255 may also be able to trigger hand off of the user equipment 210 between the access point 245 and the eNodeB 205 based on signal strength measurements or measurements of the channel conditions or some other logic related to the user quality of experience or wireless service provider policy. The MBOS management logic 255 may also be used to choose between packets in the concurrent multicast/broadcast streams provided by the access point 245 and the eNodeB 205 during the make-before-break transition.

Some embodiments of the MBOS anchor logic 260 are used to control the seamless make-before-break transfer of the multicast/broadcast session to the offload session on the network side. The MBOS anchor logic 260 may be used to replicate packets in the multicast/broadcast stream received from the content provider 235 and transmit one copy of the replicated packets (e.g. one stream) towards the eNB 205 via the depicted corresponding MBMS functions, and another copy of the replicated packets (e.g. another stream) towards the access point 245 over the wired broadband connection 262 using the offload session. The MBOS anchor logic 260 may time synchronize the two multicast/broadcast streams so that packets in the different multicast/broadcast streams are received at the MBOS manager 255 within a time window that may be determined by the buffering capacity in the MBOS manager 255. Buffering the packets received from both streams allows the MBOS manager 255 to choose between packets received in the different multicast/broadcast streams during the make-before-break transfer. Some embodiments of the MBOS anchor logic 260 may be located within or outside a Wireless Service Provider (WSP) Network. When located within WSP network, the MBOS anchor logic 260 may be optionally collocated with the WSP Multicast/Broadcast content preparation, management, or monitoring function. When located outside of WSP network it may be optionally collocated with the Video Content Provider function, e.g., the content provider 235. Locating the MBOS anchor logic 260 within WSP network may improve the end user quality of experience during the session transition in some embodiments.

Some embodiments of the MBOS gateway logic 265 are used to terminate the offload session that carries the multicast/broadcast stream over the wired broadband 262 during and after the make-before-break transfer. For example, the MBOS anchor 260 and the MBOS gateway logic 265 may use a registration process or a handshaking protocol to establish a tunnel (e.g., a unicast tunnel or a multicast tunnel) associated with the offload session. Packets in the multicast/broadcast stream may then be transmitted to the MBOS gateway logic 265 by addressing the packets to the MBOS gateway logic 265. For example, the MBOS anchor logic 260 may encapsulate the packets in a header that includes the address of the tunnel endpoint at the MBOS gateway 265. Some embodiments of the MBOS gateway 265 may implement a subscriber tracking mechanism that can be used to trigger offloading of user equipment, as described herein.

The MBOS gateway logic 265 or other logic in the access point 245 may establish a wireless connection with the user equipment 210 over an air interface 270. The distribution session may then the established over the air interface 270. Packets received via the offload session may be forwarded to the user equipment 210 over the wireless connection using the distribution session. Some embodiments of the distribution session may use either unicasting to transmit packets to the user equipment 210 or multicasting to transmit packets to the user equipment 210 and other user equipment (not shown). The distribution session may use IP tunneling or other types of tunneling, as discussed herein. The distribution session may also perform additional repackaging into TCP or VIP sessions. Some embodiments of the air interface 270 may be established according to the 3GPP standards for Wi-Fi, LTE femtocells or home eNBs, LIPA/SIPTO, or 3G cells.

In operation, when user equipment 210 transitions from outdoor to indoor, e.g., behind the obstruction 240, the user equipment 210 may switch from outdoor “macro” LTE access via the eNB 205 to indoor access via WiFi/Femto implemented in the access point 245. The MBOS management logic 255 may then send a request to the MBOS gateway logic 265 to trigger make-before-break offload session establishment over wired broadband access 262 between MBOS gateway logic 265 and MBOS anchor logic 260. The request may also indicate that the MBOS gateway logic 265 is to join the multicast/broadcast session. If user equipment 210 is the first user equipment to be receiving the multicast/broadcast session via the offload session associated with the access point 245, the MBOS gateway logic 265 triggers the access point 245 to join the multicast/broadcast session, e.g., by joining the MB-SFN associated with the multicast/broadcast session. If the access point 245 has already joined the multicast/broadcast session and is already serving one or more other user equipment that are receiving the multicast/broadcast session, the MBOS management logic 255 tunes the user equipment 210 to the corresponding channel that carries the multicast/broadcast channel.

Once the offload session has been established and the MBOS gateway logic 265 has joined the multicast/broadcast session, the MBOS anchor logic 260 starts transmitting the time-synchronized broadcast/multicast session content over the broadband connection 250 to the MBOS gateway logic 265. The MBOS gateway logic 265 terminates the tunnel and may multicast or unicast the session traffic to the user equipment 210. The MBOS management logic 255 ensures that from the application point of view the transition is smooth. For example, the offload session may be used to unicast multicast/broadcast content from the MBOS anchor 260 to an indoor access point 245 that supports Wi-Fi. The indoor access point 245 may then establish a distribution session to the user equipment 210 using Wi-Fi. For another example, the offload session may be used to unicast packets to an indoor access point 245 such as a home eNB that includes a LIPA/SIPTO gateway. The indoor access point 245 may then establish a distribution session to the user equipment 210 using LTE. For yet another example, the access point 245 may be a home eNB or a femtocell that dynamically joins a MB-SEN associated with the multicast/broadcast session by establishing a 3GPP M1 interface 231 with the MBMS gateway 220 and a 3GPP M2 interface 232 with the NICE 220 using the offload session over the wired backhaul interface 262. For yet another example, the offload session may be established with the anchor point 245 using an outdoor antenna (such as the antenna 130 shown in FIG. 1) to allow the anchor point 245 to receive LTE eMBMS and then transmit the received information over a distribution session to the user equipment 210. The outdoor antenna may be particularly useful in buses, trains, or cars.

When user equipment 210 transitions from indoor to outdoor, the user equipment 210 switches from indoor access to outdoor LTE access. The MBOS management logic 255 ensures that the transition from the UE application session perspective is seamless. The offload session between the MBOS gateway logic 265 and the MBOS anchor logic 260 may be terminated if no other user equipment associated with the access point 245 is receiving this multicast session. However, if other user equipment are receiving the multicast/broadcast session, the offload session may be maintained after the user equipment 210 switches to receiving the multicast/broadcast session via the eNB 205 so that the multicast/broadcast stream can be conveyed to the MBOS gateway 265 for transmission to the remaining user equipment that are receiving the multicast/broadcast session. Embodiments of the wireless communication system 200 may be implemented in a wide range of indoor environments, including private homes, apartment buildings, shopping malls, transportation hubs, sport complexes, etc.

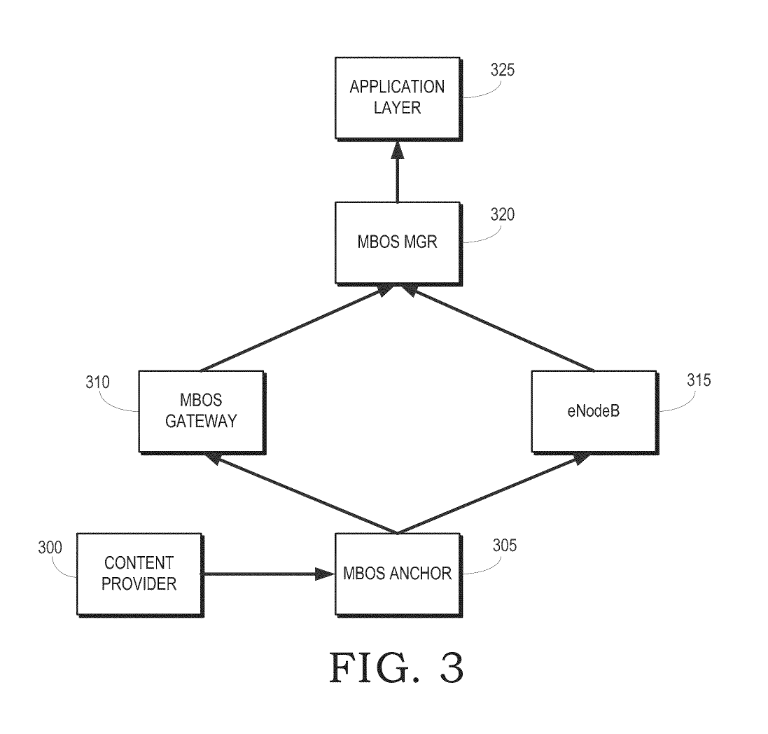

FIG. 3 is a block diagram that shows concurrent multicast/broadcast and offload sessions for conveying packets from a multicast/broadcast stream provided by a content provider 300 during a make-before-break session transfer in accordance with some embodiments. An offload session has already been established between an MBOS anchor 305 and an MBOS gateway 310, as described herein with regard to FIG. 2. The content provider 300 generates a multicast/broadcast stream and provides this stream to an MBOS anchor 305, which may replicate packets in the multicast/broadcast stream and forward copies of the replicated packets to the MBOS gateway 310 and the eNodeB 315 using the offload session. During the make-before-break transition, the MBOS management logic 320 in the user equipment may receive replicated packets for the two multicast/broadcast streams from the MBOS gateway 310 and the eNodeB 315, respectively. Since the two multicast/broadcast streams are time synchronized, the MBOS management logic 320 can choose between packets from either stream to mitigate packet loss in one of the streams or perform packet reordering and provide the selected packets to the application layer 325. Thus, the transition appears seamless from the perspective of the application layer 325.

FIG. 4 is a block diagram of a wireless communication system 400 that supports seamless make-before-break session transfers in accordance with some embodiments. Many components of the wireless communication system 400 are the same or similar to components having the same reference numeral in FIG. 2. The wireless communication system 400 differs from the wireless communication system 200 shown in FIG. 2 by using an off-the-shelf access point 405 instead of the access point 245. The off-the-shelf access point 405 does not include an MBOS gateway 265. Instead, an MBOS gateway 410 is implemented in the user equipment 415. Some embodiments of the wireless communication system 400 may also optionally omit the home eNB gateway 2112 shown in FIG. 2.

In operation, when user equipment 415 transitions from outdoor to indoor, e.g., behind the obstruction 240, the user equipment 415 may switch from outdoor “macro” LTE access via the eNB 205 to indoor access via WiFi 251 implemented in the off-the-shelf access point 405. The MBOS management logic 255 may then send a request to the MBOS gateway logic 410 to trigger make-before-break session transfer from the multicast/broadcast session to an offload session established between MBOS gateway logic 410 and MBOS anchor logic 260. Once the offload session has been established, the MBOS anchor logic 260 starts transmitting the time synchronized broadcast/multicast session content over the broadband connection 250 to the MBOS gateway logic 410 using the offload session. For example, the off-the-shelf access point 405 may unicast the multicast/broadcast stream over the air interface 270 using a tunnel to the MBOS gateway logic 410. The MBOS gateway logic 410 terminates the tunnel and may then convey the session traffic to the user equipment 415. The MBOS management logic 255 ensures that from the application point of view the transition is smooth.

When user equipment 415 transitions from indoor to outdoor, the user equipment 415 switches from indoor access to outdoor LIE access. The MBOS management logic 255 ensures that the transition from the UE application session perspective is seamless. The offload session between the MBOS gateway logic 410 and the MBOS anchor logic 260 may be terminated if no other indoor user equipment are participating in the offload session. Embodiments of the wireless communication system 200 may be well-suited to home environments in which the homeowner uses the off-the-shelf access point 405.

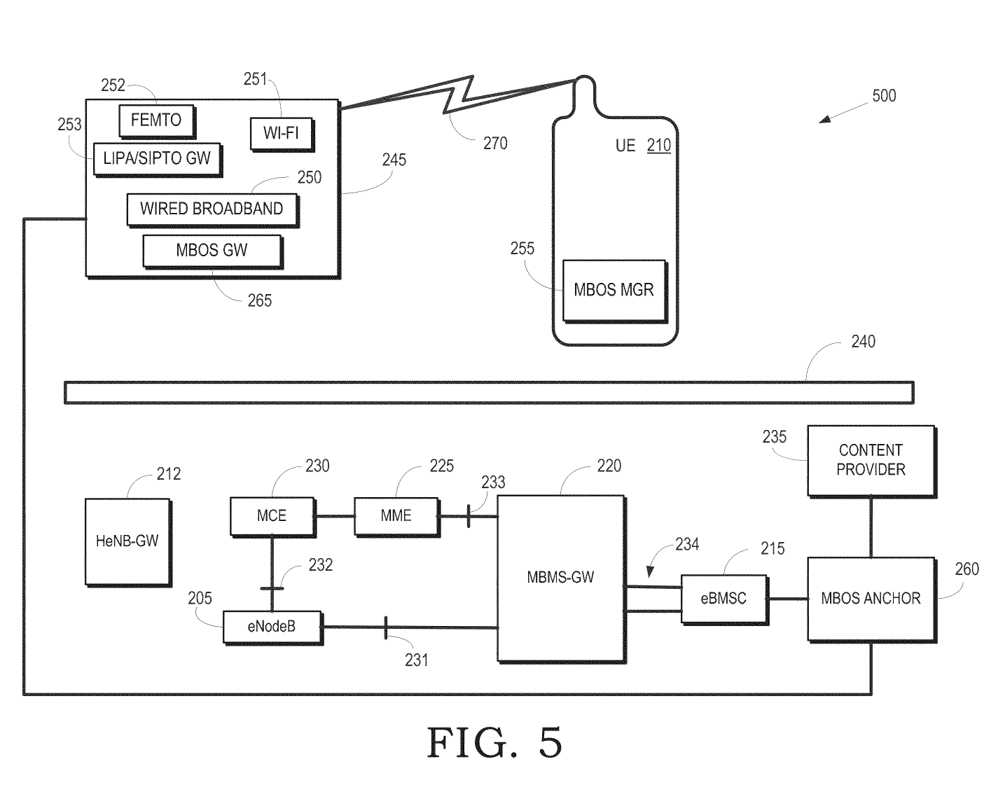

FIG. 5 is a block diagram of a wireless communication system 500 that supports seamless make-before-break transitions of multicast/broadcast sessions in accordance with some embodiments. Many components of the wireless communication system 500 are the same or similar to components having the same reference numeral in FIG. 2. The wireless communication system 500 differs from the wireless communication system 200 shown in FIG. 2 by using LIPA/SIPTO gateway 253 in the access point 245 to offload the multicast/broadcast session.

In operation, when user equipment 210 transitions from outdoor to indoor, e.g., behind the obstruction 240, the user equipment 210 may switch from outdoor “macro” LTE access via the eNB 205 to indoor access via WiFi/Femto cell or home eNodeB utilizing LIPA/SIPTO gateway implemented in the access point 245 and the multicast/broadcast session may be offloaded from the eNB 205 to the LIPA/SIPTO gateway 253 in the access point 245. The MBOS management logic 255 may then send a request to the MBOS gateway logic 265 to trigger make-before-break tunnel establishment between MBOS gateway logic 265 and MBOS anchor logic 260. The MBOS gateway logic 265 and establishes a unicast tunnel to the MBOS anchor logic 260, which can then unicast the multicast/broadcast stream to the MBOS gateway logic 265. The access point 245 may then utilize LIPA/SIPTO gateway 253 and unicast the offloaded stream to the user equipment 210 or multicast the offloaded stream to a plurality of user equipment including the user equipment 210.

When user equipment 210 transitions from indoor to outdoor, the user equipment 210 switches from indoor access to outdoor LTE access. The MBOS management logic 255 ensures that the transition from the perspective of the UE application session is seamless. The offload session between the LIPA/SIPTO gateway 253 and the MBOS anchor logic 260 may be terminated if no other user equipment associated with the access point 245 is receiving this multicast session. However, if other user equipment are receiving the multicast/broadcast session, the offload session may be maintained after the user equipment 210 switches to receiving the multicast/broadcast session via the eNB 205 so that the multicast/broadcast stream can be conveyed to the LIPA/SIPTO gateway 253 for transmission to the remaining user equipment that are receiving the multicast/broadcast session. Embodiments of the wireless communication system 200 may be implemented in a wide range of indoor environments, including private homes, apartment buildings, shopping malls, transportation hubs, sport complexes, etc.

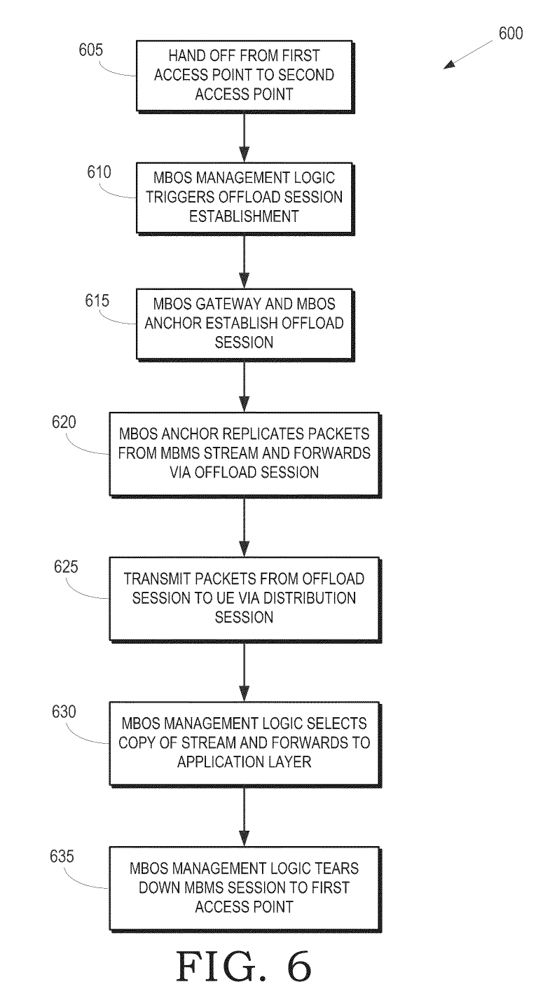

FIG. 6 is a flow diagram of a method 600 for seamless make-before-break session transfer in accordance with some embodiments. User equipment such as the user equipment 210 shown in FIG. 2 is receiving or is scheduled to receive, from a first access point, a multicast/broadcast stream associated with the multicast/broadcast session. At block 605, the user equipment hands off from the first access point to a second access point. For example, the user equipment may hand off from an eNodeB to a Wi-Fi access point in response to a handoff trigger that is generated by the user equipment or in the network in response to the user equipment moving into an obstructed area that is served by the Wi-Fi access point. The hand off may be triggered by a network entity or MBOS management logic implemented in the user equipment. At block 610, the MBOS management logic triggers offload session establishment by sending a request to MBOS gateway logic, which may be implemented in the user equipment or in the second access point, as discussed herein. At block 615, the MBOS gateway logic and MBOS anchor logic on the network side establish the offload session, which may include establishing a tunnel that can be used to convey the multicast/broadcast stream.

At block 620, the offload session has been established. The MBOS anchor logic can replicate packets from the multicast/broadcast stream and forward them to the MBOS gateway logic via the offload session. For example, the MBOS anchor logic may encapsulate one copy of the packets in a header that includes an address that indicates that the MBOS gateway logic is the terminating and point of the tunnel. At block 625, the access point can transmit packets received via the offload session to user equipment using a distribution session established between the access point and the user equipment. The MBOS management logic may then receive copies of the packets in the multicast/broadcast stream from the eNodeB and the MBOS gateway logic via the distribution session. At block 630, the MBOS management logic selects one of the copies of the packets received in the concurrent streams and forwards this to the application layer. Some embodiments of the MBOS management logic may perform repackaging of packets received in the concurrent streams so that the application layer cannot distinguish between packets associated with the different streams. The MBOS management logic can then decide that the multicast/broadcast session with the MBOS gateway logic has been established (e.g., in response to successfully receiving a selected number of packets from the MBOS gateway logic) and it is no longer necessary to maintain the multicast/broadcast session with the eNodeB. At block 635, the MBOS management logic tears down the multicast/broadcast session to the first access point to complete the make-before-break transition.

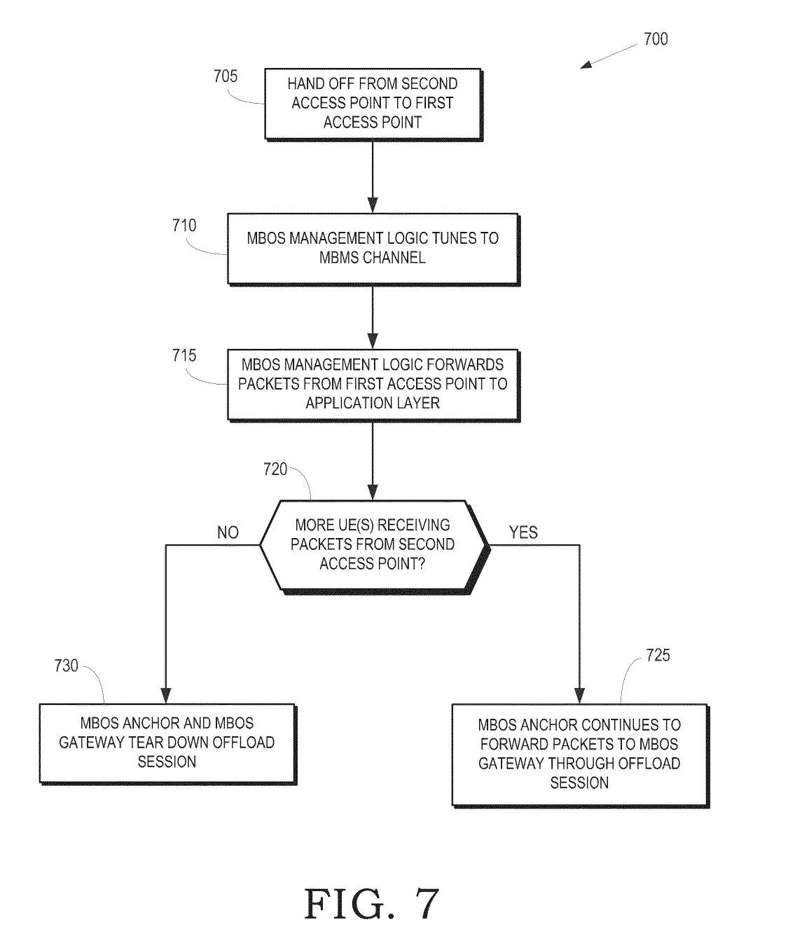

FIG. 7 is a flow diagram of a method 700 for ending communication between MBOS management logic in a user equipment and MBOS anchor logic in a wireless communication system in accordance with some embodiments. Initially, the user equipment is receiving copies of packets from a multicast/broadcast stream from the MBOS anchor logic via MBOS gateway logic using an offload session between the MBOS anchor logic and the MBOS gateway logic, as discussed herein. At block 705, the user equipment hands off from the second access point to a first access point, e.g., in response to a handoff trigger generated by the user equipment or in the network in response to the user equipment leaving an obstructed area served by the second access point. At block 710, the MBOS management logic in the user equipment tunes the user equipment to a multicast/broadcast channel provided over an air interface by the first access point. The MBOS management logic may therefore begin receiving packets using the multicast/broadcast channel and, at block 715, the MBOS management logic begins forwarding packets in the multicast/broadcast stream received from the first access point to the application layer of the user equipment. The MBOS gateway logic then determines, at decision block 720, whether any more user equipment are still receiving copies of packets from the multicast/broadcast stream from the second access point using the offload session. If other user equipment are still receiving the packets from the second access point, the MBOS anchor logic continues to forward packets to the MBOS gateway logic via the offload session at block 725. If no other user equipment are receiving the packets from the second access point, the MBOS anchor logic and the MBOS gateway may tear down the offload session at block 730.

In some embodiments, certain aspects of the techniques described above may implemented by one or more processors of a processing system executing software. The software comprises one or more sets of executable instructions stored or otherwise tangibly embodied on anon-transitory computer readable storage medium. The software can include the instructions and certain data that, when executed by the one or more processors, manipulate the one or more processors to perform one or more aspects of the techniques described above. The non-transitory computer readable storage medium can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)). The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus, comprising:
multicast/broadcast offload session (MBOS) anchor logic to establish an offload session to an MBOS gateway to provide a multicast/broadcast stream to user equipment in response to the user equipment handing off from a first access point to a second access point, wherein the MBOS anchor logic is to establish the offload session concurrently with providing the multicast/broadcast stream to the user equipment via the first access point.

2. The apparatus of claim 1, wherein the MBOS anchor logic is to establish the offload session in response to a handoff trigger and complete establishment of the offload session prior to discontinuing provision of the multicast/broadcast stream to the user equipment via the first access point.

3. The apparatus of claim 1, wherein the MBOS anchor logic is to replicate the multicast/broadcast stream and to concurrently provide one copy of the multicast/broadcast stream to the first access point and another copy of the multicast/broadcast stream to the MBOS gateway using the offload session.

4. The apparatus of claim 3, wherein the MBOS anchor logic is to time synchronize the copies of the multicast/broadcast stream.

5. The apparatus of claim 4, wherein the MBOS anchor logic is to time synchronize the copies of the multicast/broadcast stream to within a tolerance ranging from 10 milliseconds to 300 milliseconds.

6. The apparatus of claim 3, wherein the MBOS anchor logic is to address packets including content from one of the copies of the multicast/broadcast stream to the MBOS gateway for transmission via a tunnel associated with the offload session.

7. The apparatus of claim 1, wherein the MBOS anchor logic is to trigger hand off to or from the second access point based on signal strength measurements associated with the second access point and the user equipment.

8. The apparatus of claim 1, comprising a broadband connection between the MBOS anchor logic and the MBOS gateway, and wherein the offload session is established over the broadband connection.

9. The apparatus of claim 1, wherein the MBOS anchor logic is to tear down the offload session in response to the user equipment handing off from the second access point if no other user equipment are concurrently receiving the multicast/broadcast stream via the offload session.

10. An apparatus, comprising:
multicast/broadcast offload session (MBOS) gateway logic to:
establish an offload session to MBOS anchor logic for receiving multicast/broadcast content for user equipment, wherein the offload session is established in response to the user equipment handing off from a first access point to a second access point; and
provide the multicast/broadcast content to the user equipment.

11. The apparatus of claim 10, wherein the MBOS gateway logic is to establish the offload session in response to a handoff trigger and complete establishment of the offload session prior to discontinuing provision of the multicast/broadcast stream to the user equipment via the first access point.

12. The apparatus of claim 10, wherein the MBOS gateway logic receives packets including the multicast/broadcast content via the offload session, and wherein the packets received via the offload session are addressed to the MBOS gateway logic.

13. The apparatus of claim 12, wherein the IV 30S gateway logic is implemented in the second access point.

14. The apparatus of claim 13, wherein the MBOS gateway logic provides the packets to the user equipment using at least one of unicasting, multicasting, or broadcasting the packets over an air interface between the second access point and user equipment.

15. The apparatus of claim 12, wherein the MBOS gateway logic is implemented in the user equipment, and wherein providing the multicast/broadcast stream comprises providing the packets to MBOS management logic implemented in the user equipment.

16. The apparatus of claim 10, comprising a backhaul connection between the MBOS anchor logic and the MBOS gateway logic, and wherein the offload session is established over the backhaul connection.

17. The apparatus of claim 11, wherein the MBOS gateway logic is to tear down the offload session in response to the user equipment handing off from the second access point if no other user equipment are concurrently receiving the multicast/broadcast stream via the offload session.

18. An apparatus, comprising:
multicast/broadcast offload session (MBOS) management logic to trigger establishment of an offload session terminated by MBOS gateway logic for providing a multicast/broadcast stream to the user equipment in response to the user equipment handing off from a first access point to a second access point, wherein the trigger is provided concurrently with the user equipment receiving the multicast/broadcast stream via the first access point.

19. The apparatus of claim 18, wherein the MBOS gateway logic is implemented in the second access point, and wherein the user equipment receives packets including content from the multicast/broadcast stream that are unicast, multicast, or broadcast by the MBOS gateway logic over an air interface between the second access point and user equipment.

20. The apparatus of claim 18, comprising the MBOS gateway logic, wherein the MBOS gateway logic receives packets including content from the multicast/broadcast stream via the offload session, and wherein the packets received via the offload session are addressed to the MBOS gateway logic.

21. The apparatus of claim 18, comprising application layer logic, and wherein the MBOS management logic concurrently receives copies of the multicast/broadcast stream via the first access point and the second access point in response to triggering establishment attic offload session, and wherein the MBOS management logic provides one of the copies to the application layer logic.

22. The apparatus of claim 18, wherein the MBOS management logic triggers hand off from the first access point to the second access point based on signal strength measurements.
